(19) United States
(12) Patent Application Publication
(10) Pub. No.: US 2003/0202798 A1
(43) Pub. Date: Oct. 30, 2003

(54) Polarization mode dispersion compensator parallel monitoring and control architecture

(75) Inventors: Patrick C. Chou, Fremont, CA (US); Bogdan Hoanca, Anchorage, AK (US)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Phaethon Communications, Fremont, CA

(21) Appl. No.: 10/134,878

(22) Filed: Apr. 29, 2002

(51) Int. Cl. H04B 10/00

(52) U.S. Cl. 398/159

(57) ABSTRACT

A parallel monitored and controlled optical PMD compensator comprises a branch optical signal split from an optical signal path. A polarization controller (PC) and differential group delay are disposed in each of the paths. A controller adjusts polarization compensation of the PCs in response to PMD dispersion of the branch optical signal. A PMD monitor is preferably disposed in the branch path providing a monitor signal to the controller for use in adjusting the PCs. A polarization rotator may inject a reference signal into the paths with the PC disposed in the branch path acting as a polarization scrambler. A state of polarization (SOP) of the reference signal may be monitored by polarimeters disposed in both paths and the SOP of the reference signal in the branch path may be provided to the controller for adjusting polarization compensation of the inline PC.

### RELATED APPLICATION

The present invention is related to copending, commonly assigned U.S. patent application Ser. No. 09/940,183, entitled Low Cost Wave Plate Emulator for Polarization control in a Fiber Optic System, filed on Aug. 27, 2001, the disclosure of which is incorporated by reference herein in its entirety.

### TECHNICAL FIELD

The present invention generally relates to fiber optical communications technologies and more specifically to polarization mode dispersion compensator parallel monitoring and control architectures.

### BACKGROUND OF THE INVENTION

Optical transmissions inside a single mode fiber are subject to at least two types of fundamental limitations, power loss and dispersion. Such limitations are often represented as a penalty to the distance an optical signal can be transmitted subject to a tolerable signal to noise ratio. Advances in optical amplification technologies using erbium doped fiber amplifiers (EDFA) have provided, to a large extent, effective solutions to overcome loss limited transmission distance problems. On the other hand, solutions to dispersion problems, which are highly bit rate dependent, have not yet been effectively forthcoming.

A particular dispersion mode problem in fiber optic telecommunications is polarization mode dispersion (PMD) where optical pulses spread out in time. Pulse widths get longer and limit the data rate that can be transmitted. Due to physical birefringence in the fiber which is amplified over multi-kilometer distances, the front part of a pulse and the back part of a pulse will start to separate and develop different polarizations. Birefringence causes one polarization mode to travel slower than the other.

Prior art polarization mode dispersion compensators (PMDC) are plagued by high order effects such as local sub-optima which can severely degrade the performance of a compensator. Most architectures involve feedback controlled inline compensators, which attempt to track an optimum polarization state as it drifts. Because the line data runs through the compensator, such a PMDC will cause transmission errors if the PMDC deviates from the optimum polarization state. Therefore, prior art PMDCs are not given the freedom to look elsewhere in the optical parameter space for an optimum polarization state, and thus the PMDC may be operating at a local rather than a global optimum polarization state.

At a receiver, a PMDC may be installed to cancel out the effect of the distortions that occur along the optical transmission fiber line. Many different techniques for compensating polarization mode dispersion (PMD) in fiber optic systems have been proposed. The most commonly reported type is a feedback-based inline optical compensator. With attention directed to FIG. 1, conventional prior art PMDC 100 is shown for reference. Incoming light signal 101 is processed by endless polarization controller (PC) 102 and PMD in the signal is compensated by inline differential group delay (DGD) 103. The control parameters on endless PC 102 are dithered by controller 104 so that a monitor signal at Monitor (Mon) 105 is always optimized. In such a prior art compensator 100, consisting of endless polarization controller (PC) 102 in sequence with a differential group delay (DGD) 103, DGD 103 generally mirrors the PMD of the incoming signal. DGD 103 can be adjusted by manipulating a magnitude of the birefringence of DGD 103, or more conventionally, manipulating settings for endless PC 102. The feedback loop of PMDC 100 generally optimizes a monitor signal at MON 105. Controller 104 searches for the correct parameters for endless PC 102. By extension, the value of the DGD may be optimized as well. Problematically, architecture 100 is sensitive to parameter space distortions from the presence of high order PMD.

Polarization controllers may involve one of several prior art technologies, such as lithium niobate based PCs. Problematically, an additional prior art constraint is that the PC employed in prior art PMDCs must be endless, meaning that the PC can transform polarization states which are varying without the need to reset the PC or its control voltages. Minimally, the PC must at least be able to be reset without disrupting the optical signal in order to provide interruption free signal output.

The DGDs of a prior art PMDC employ the first order of PMD, which results in a differential group velocity delay between two orthogonal states of polarization. A DGD may be comprised of a piece of birefringent polarization maintaining fiber or a birefringent crystal, such as calcite, where an X axis polarization has a larger index of refraction than a Y axis polarization, with the signal propagating along the Z axis. The monitor makes a measure of output signal quality, such as a degree of polarization or state of polarization (SOP). The control is a processor based device which optimizes the monitor signal by dithering the PC controls, such as control voltages.

Conventional inline compensator 100 tracks a minimum signal distortion state using a feedback based dithering scheme and does not have the freedom to explore other portions of the optical parameter space. This can be problematic if the minimum distortion state turns into a local sub-minimum, or disappears as the optical parameter space evolves with temperature fluctuations and vibrations in the transmission fiber.

A problem arises in certain cases because the endless PC generally has two or three degrees of freedom. To optimize the degrees of freedom, two or three voltages, or other parameters controlling the degrees of freedom are adjusted until the best monitor signal is obtained. Problematically, more than one setting on the PC may give a good monitor signal. Generally, optimum acceptable peaks for the monitored output signal in the optical parameter space are sought. These optimum signal quality peaks are time dependent based on thermal and acoustic fluctuations of the fiber. There are multiple peaks, some may be higher than others, and essentially prior art feedback schemes attempt to track the peaks as they move around in local parameter space. The optimal control voltages on the PC are maintained to provide the best compensation. However, prior art feedback systems do not ensure that the highest global peak is being employed. The prior art systems only provide local peaks which over time transform. Thus, local peaks may not be the global peak. The prior art has failed to resolve this issue. Prior art systems employ the aforementioned feedback loop assuming that a global peak results, which may or may not be the case. Problematically, a prior art feedback loop does not look to the entire parameter space.

In prior art FIG. 2, the afore-described feedback control concept is applied to two-section PMDC 200 to control PMD of input optical signal 201. The prior art illustrated in FIG. 2 provides more degrees of freedom then the structure depicted in FIG. 1. Two compensating DGDs 203 and 207 are employed each having its own polarization controller 202 and 206, respectively. The structure for monitoring to provide control is similar to FIG. 1. In the two section PMDC 200 of FIG. 2, monitor 205 feeds back an output signal to controller 204. Signal 201 is optimized by controlling the control voltages on both PCs 202 and 206. The difference is that more parameters, or degrees of freedom, are provided. However, the aforementioned problem with the local and global optimum peaks is still present.

A scheme which provides offline analysis of PMD is described in “Real-Time Principal State Characterization for Use in PMD Compensators,” by Chou, Fini, and Haus, IEEE PTL vol. 13, no. 6, June 2001, which is incorporated by reference herein in its entirety and which is co-authored by a present inventor. In that work, an optical branch characterizes first order PMD and feeds forward the information to a dither-free polarization controller and compensator. However, the scheme disclosed therein employs a polarization scrambled at the transmitter to provide multiple measurable polarizations. Therefore alteration of the optical signal transmitter is required for such a PMD monitoring system. Furthermore, this scheme employs estimations of PMD derived from measurements of the SOP and degree of polarization (DOP) for an optical signal rather than direct measurements of the signal's PMD.

### BRIEF SUMMARY OF THE INVENTION

The present invention is directed to systems and methods for PMDC parallel architectures used to scan the entire optical parameter space offline to monitor PMD and control PMDCs. The purpose of the architectures described herein is to provide the control processor of a dynamic PMD compensator with full characterization of a compensator's parameter space. Such a parallel architecture preferably contains a power splitter which allows the PMDC parameter space to be analyzed in a branch path without disturbing the data flowing through the inline path. The branch path contains compensator components, namely at least a PC and DGD. In one embodiment, these components are a reproduction of the inline PC and DGD. The present parallel architecture also includes a signal quality monitor, and may contain other polarization sensing devices for analysis purposes. The present technique can be expanded to include multi-section PMDCs. The present systems and methods do not require altering the optional signal transmitter. Additionally, the methods and systems described herein operate independently of the type of monitoring used. Therefore, the present methods and systems may employ measurements systems that more closely correlated to signal impairment than DOP, thereby improving overall performance and reliability.

The purpose of this PMDC architecture is to operate the compensator with knowledge of the full parameter space. A parallel architecture is beneficial because analysis of a split off signal branch, a parallel branch, allows application of control parameters, such as control voltages, to a polarization controller which may distort the signal further or in such ways that may not necessarily optimize the signal, but which will facilitate analysis of the entire parameter space. This analysis cannot be carried out with a prior art inline compensator because the signal is passing through the prior art compensator. So if the voltages are varied in a prior art inline compensator to determine global or local peaks, the signal itself is distorted. Preferably, a PC adjusting the actual signal is optimizing the signal at all times. In the present parallel architecture the signal being analyzed is not inline; the signal being analyzed is not actually being received. Therefore, it may be distorted for the purpose of analysis, because the analysis signal is off-line. The present invention allows parameter space to be fully swept, facilitating measurement of the monitored analysis signal at different combinations of control voltages on the PC. This facilitates determination of global maximum and local peak PMD compensation parameters. This information is very useful and is advantageously generated off-line.

The present invention sweeps out the full optical parameter space. Control electronics looks through the entire parameter space and finds the best PMD compensation value. To sweep out the parameter space, the control voltages of the offline PC are preferably ramped to generate every combination of control voltages. This provides a monitor signal associated with each combination, essentially defining the parameter space. Advantageously, the parallel architecture provides the ability to scan the entire optical parameter space so that problems associated with local sub-optima can be eliminated. For example, scanning the entire space can ensure that the global optimum is selected, not a local one. Additionally, recovery from an outage can be faster if an inline PC does not need to search the entire optical parameter space. As a further advantage, the offline PC in selected embodiments of the present invention need not be endless.

Another advantage to knowing the entire parameter space is that evolution of the parameter space can be tabulated allowing better decisions to be made by control circuitry about how to vary control, such as control voltages, on a PC over time. For example, it may be desirable to be able to choose an optimal path along the parameter space to avoid the generation of outages. In the prior art, an inline PC is entirely dependent on feedback control. An algorithm to control prior art PCs has a path which is a function of the algorithm itself and how the parameter space is perceived as varying. This leads to resets of non-endless PCs, or a need for complicated endless algorithms applied to avoid resets. This can also lead to non-optimal paths in the parameter space which result in momentary signal outages. Full knowledge of the parameter space allows off-line optimization in real-time without a need for resets or complicated algorithms to avoid resets.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIG. 1 is a diagramatic representation of a prior art PMD compensator with an integrated inline monitoring system;

FIG. 2 is a diagramatic representation of a prior art two step compensator with an integrated inline monitoring system;

FIG. 3 is a diagramatic representation of an embodiment of the present PMDC parallel architecture;

FIG. 4 is a diagramatic representation of an embodiment of the present PMDC parallel architecture employing a switched reference signal;

FIG. 5 is a diagramatic representation of a dither-free embodiment of the present PMDC parallel architecture employing a switched reference signal;

FIG. 6 is a diagramatic representation of an embodiment of the present PMDC parallel architecture employing a multi-wavelength reference signal;

FIG. 7 is a diagramatic representation of a dither-free embodiment of the present PMDC parallel architecture employing a multi-wavelength fixed reference signal; and

FIG. 8 is a diagramatic representation of a multisection dither-free embodiment of the present PMDC parallel architecture employing a multi-wavelength fixed reference signal.

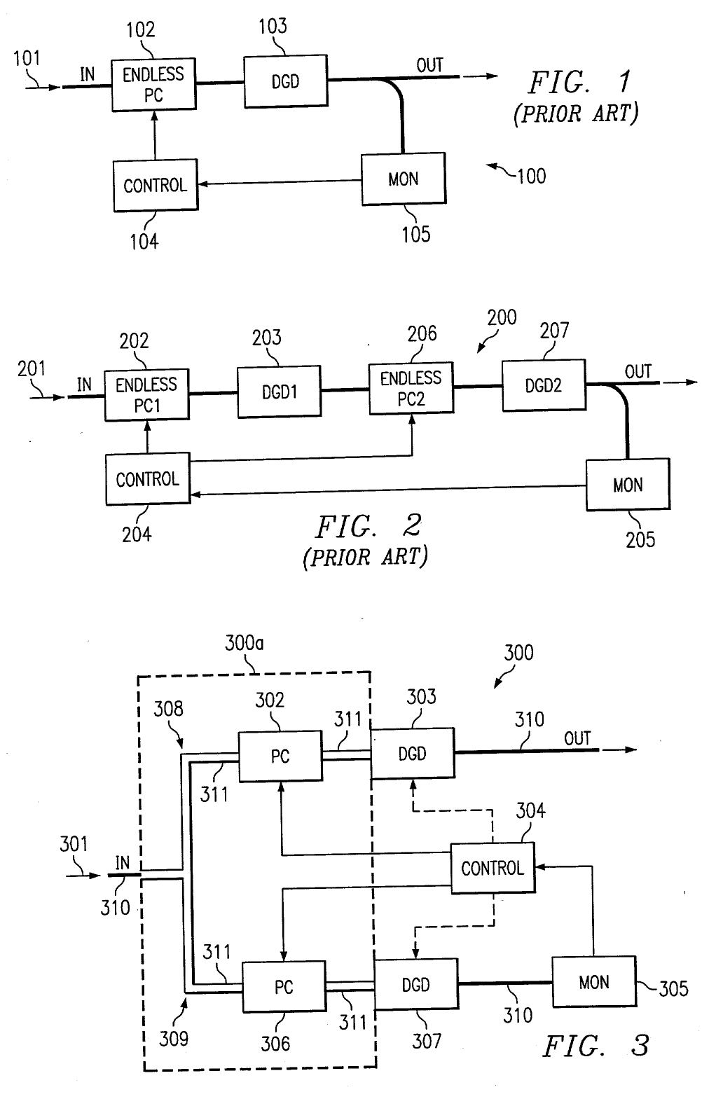

### DETAILED DESCRIPTION

Turning to FIG. 3, there is shown system 300 implementing an embodiment of the present PMDC parallel monitoring and control architecture. Optical signal 301 is split between inline path 308 and branch path 309, but the strength of signal 301 is not necessarily split between the paths. Optical fiber 310 is used as an optical transmission medium in portions of the system and paths requiring well-controlled polarization transformation may employ free space optical beams 311, planer optical waveguides or the like. Herein the phrase “free space path” or the like is intended to denote optical paths which preferably have no polarization transformation or at least in which polarizations transformations are well characterized and known. Such “free space paths” may in fact be free space optical beams or they may take the form of planer optical waveguides or the like. Control parameters for inline path 308 may include control voltages applied to PC 302 and, if desired, a value adjustment of DGD 303. Preferably, within box 300a, branch 309 and inline path 308 have matching polarization transformations. Additionally, PCs 302 and 306 preferably match such that matching control voltages result in matching input SOPs at DGDs 303 and 307, respectively, for any incoming SOP. This configuration allows controller 304 to determine the best inline PC voltages based on measurements in branch 309. Random problems with local minimal can then be handled in a deliberate manner, rather than relying on statistics of overall PMD over a period of time. In operation, the control parameters are fully swept in branch 309 for branch PC 306. When the optimum parameters which provide the best PC output for PMD compensator by DGD 307 at MON 305 are found, the parameters of inline PC 302 are adjusted to match optimum parameters found in branch path 309.

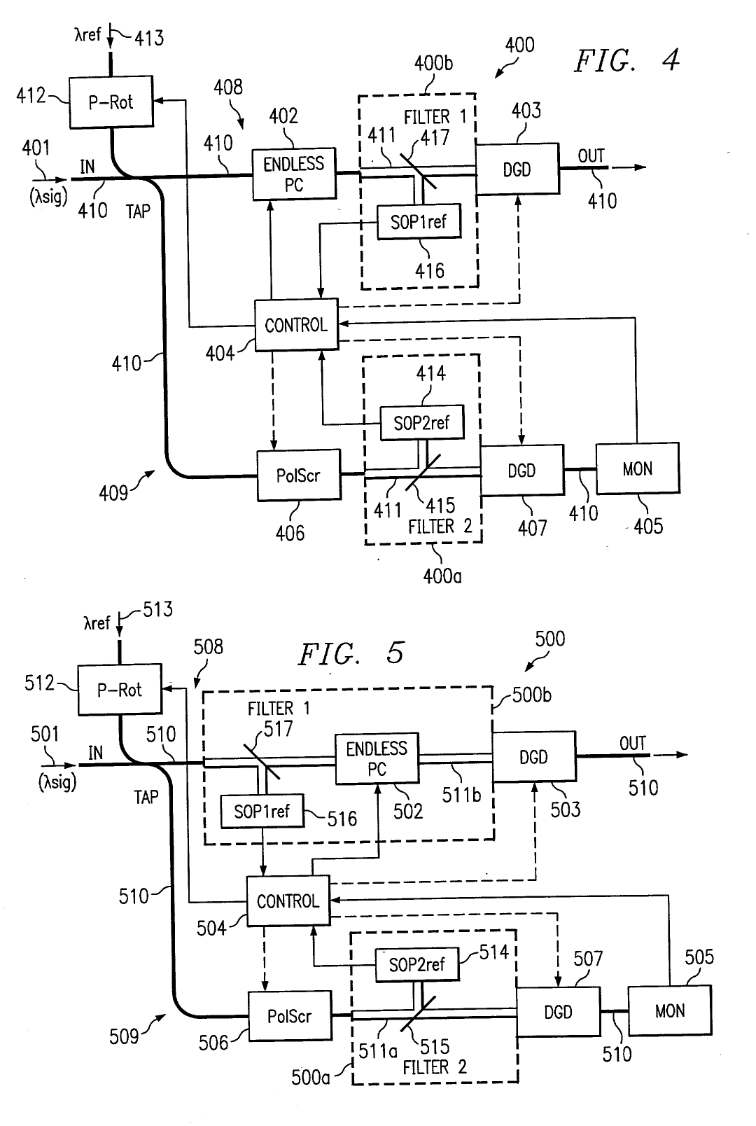

Alternatively, a branch path may not have a polarization transformation matching that of the inline path, as illustrated in FIGS. 4 through 8. Preferably, in these embodiments, the control parameters are fully swept in the branch, and when the optimum parameters are found, the parameters of the inline compensator are adjusted to emulate the settings in the branch PC(s) by means of sensors in both the inline and branch paths. This sensing can be done in a number of ways, some of which are illustrated in FIGS. 4 through 8.

FIG. 4 shows embodiment 400 for a single section parallel architecture PMDC using sensors. A polarization transformer (P-Rot) 412 modulates continuous wave (CW) reference signal 413 at wavelength λ_{ref} to provide two different input SOPs. Reference signal 413 is injected into optical fiber 410 carrying optical signal 401 at wavelength λ_{sig}. Optical signal 401 and reference signal 413 are tapped to form branch 409 parallel to inline path 408. Optical signal 401 and reference signal 413 are scrambled by a polarization controller acting as a polarization scrambler (PolScr) 406. The polarization controller making up polarization scrambler 406 need not necessarily be endless. Control processor 404 may be used to control polarization scrambler 406. However, a separate control processor may be used to cycle through control voltages for polarization scrambler 406 as there is no need for synchronization with inline PC 402. The reference signal is monitored by polarimeter SOP2_{ref} 414 via a filtering splitter Filter2 415. The polarization transformation in branch 409 can be uniquely identified by two SOPs measured at SOP2ref 414, corresponding to the two different input SOPs generated by P-Rot 412. The filtered scrambled signal is sent through compensator 407 in the form of a DGD and the signal distortion level is measured by monitor (Mon) 405. Control processor 404 records the monitor signal and associated SOPs from SOP2_{ref} 414 for the full range of polarization transformations induced by PScr 406, and determines which transformation yields the least PMD after DGD 407. Control processor 404, reads SOP1_{ref} 416, and dithers inline endless PC 402 so that the inline transformation matches the optimum found in branch 409. To dither control parameters of endless PC 402, each control parameter is varied to determine whether a new parameter results in approaching or diverging from the SOP target. Each control parameter is evaluated and the SOP is optimized. For example, with three control voltages, the first one is optimized, then the second one is optimized, then the third, and then the first is optimized again, etc., constantly. Thus, a minimum separation from the target SOP is maintained. PMD at the output should be at the optimal level as long as inline and branch DGDs 403 and 407 are approximately equal.

In embodiment 400 of FIG. 4, the two branches do not need to match. The SOPs which are tapped off with Filter2 415 and Filter1 416, can be used to ensure that the optimum polarization transformation found in branch 409 can be applied to endless PC 402. While sweeping out parameter space with polarization scrambler 406, SOP2_{ref} 414 is preferably monitored twice for each combination of control voltages, to take two measurements in order to evaluate the polarization transformation. Generally, a single SOP measurement will not fully characterize a polarization transformation. So reference signal input has polarization rotator 412 which preferably generates two different SOPs. Preferably, the two SOPs do not match and are not orthogonal to each other. By measuring the SOP in branch 409 at SOP2_{ref} 414 for the two reference signal polarization states, the polarization transformation for branch 409, up to DGD 407 can be fully characterized. Given the optimum polarization transformation in branch 409, characterized by measurement at SOP2_{ref} 414, control processor 404 only has to compare measurement at SOP2_{ref} 414 to measurements at SOP1_{ref} 416 in inline path 408 to provide optimal PMD compensation control settings for endless PC 402. The correct control parameters on inline endless PC 402 may not be the same as the optimal control parameters found for polarization scrambler 406. To provide optimal control parameters to inline PC 402, the two SOPs corresponding to the two different reference polarizations can be matched, thereby matching the polarization transformations in inline path 408 and branch path 409. Thusly, embodiment 400 avoids the use of matching PCs and many of the free space paths of embodiment 300 of FIG. 3. Free space paths 411 are required at Filter2 (415) and Filter1 (417) to insure accurate measurement of SOP2_{ref} 414 and SOP1_{ref} 416, respectively. Dashed outlines 400a and 400b encompass free space optical beam paths or other well defined optical path in which the polarization transformation between SOP_{ref} measurements and the inputs of their respective DGDs are known. Preferably, no polarization transformation takes place within each of boxes 400a and 400b.

FIG. 5 shows single section PMDC embodiment 500 which does not require dithering of inline endless PC 502. Inline endless PC 502 should be well characterized and controlled for embodiment 500, meaning an accurate mapping of control voltages to polarization transformations is required and stored in the memory of control processor 504. A polarization transformer (P-Rot) 512 modulates continuous wave (CW) reference signal 513 at wavelength λ_{ref} to provide two different input SOPs. Reference signal 513 is injected into optical fiber 510 carrying optical signal 501 at wavelength λ_{sig}. Optical signal 501 and reference signal 513 are tapped to form branch 509 and scrambled by a polarization controller acting as a polarization scrambler (PolScr) 506. The polarization controller making up polarization scrambler 506 need not necessarily be endless. Control processor 504 may be used to control polarization scrambler 506. However, a separate control processor may be used to cycle through control voltages for polarization scrambler 506 as there is no need for synchronization with inline PC 501. The reference signal is monitored by polarimeter SOP2_{ref} 514 via filtering splitter, Filter2 515. The polarization transformation in branch 509 can be uniquely identified by two SOPs measured at SOP2_{ref} 514, corresponding to the two different input SOPs generated by P-Rot 512. The filtered scrambled signal is sent through a compensator in the form of DGD 507 and the signal distortion level is measured by monitor (Mon) 505. SOP1_{ref} 516 is measured at the input of inline endless PC 502, and the control processor 504 calculates the correct setting so that the output of endless PC 502 matches the optimal value determined from measurements in branch 509. After control processor 504 has found the optimum pair of SOPs to occur at inline DGD 503, the SOP1_{ref} 516 is measured in inline path 508, via filter, 517 before endless PC 502. Processor 504 calculates what voltages or other control parameters need to be applied to endless PC 502 in order to obtain the desired SOPs after inline endless PC 502. No dithering is required by embodiment 500 because endless PC 502 is well characterized. Present embodiment 500 employs only a measurement, calculation and application of tabulated voltages found in memory of controller 504. The preferred optimal reference SOP, determined from measurements at SOP2_{ref} 514, is generated by endless PC 502 at the input of the DGD 503. Free space paths 511a and 511b, outlined by boxes 500a and 500b, respectively, are preferably regions in which there is no transformation on the polarization transformation is known. A measurement at SOP1_{ref}, for example, uniquely identifies the reference SOP entering endless PC 502.

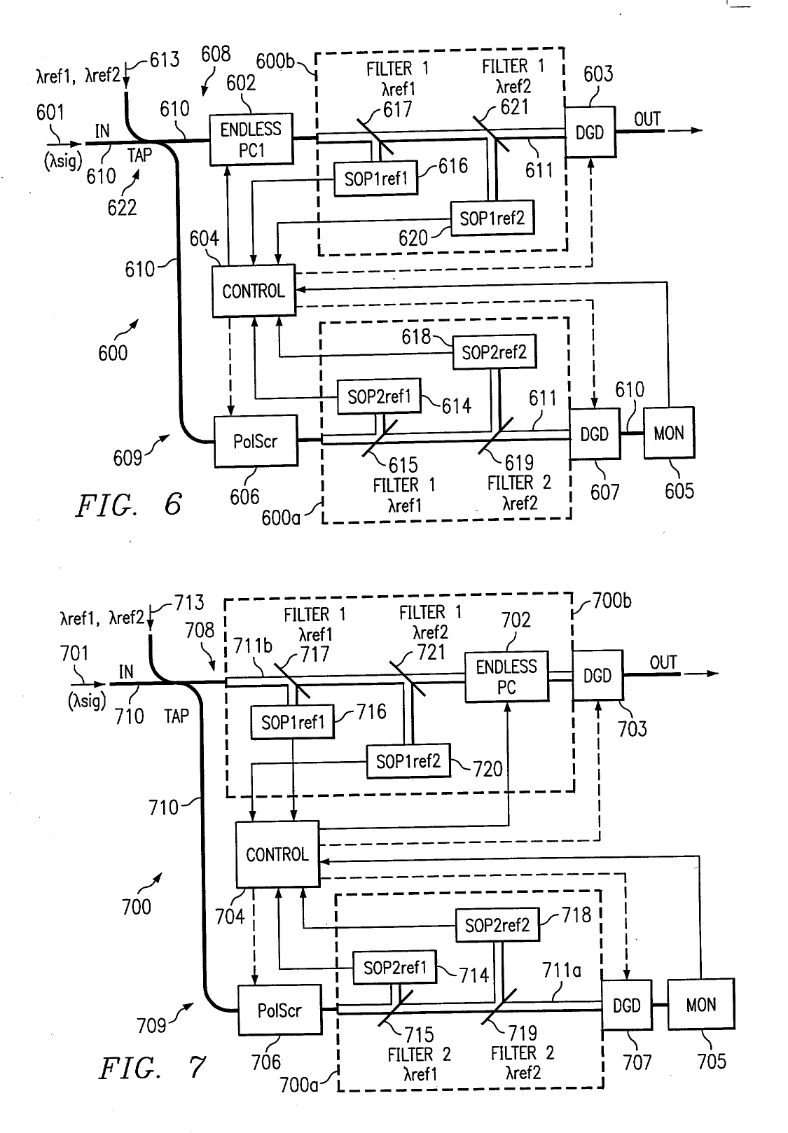

FIGS. 6 and 7 show variations of the configuration in FIG. 3. Instead of modulating the polarization of a single reference signal as embodiments 400 and 500 of FIGS. 4 and 5, a second reference signal is added at a different wavelength. Two filters and SOP monitors are used both inline and in the branch.

FIG. 6 shows embodiment 600 of the present PMDC parallel monitoring architecture. Rather than modulating polarization of a single reference signal, a second reference signal is added at a second wavelength (λ_{ref}) to have two separate known states of polarization in order to uniquely identify the polarization transformation between tap 622 and the reference measurement at MON 605. Reference signal 613 having wavelengths λ_{ref1} and λ_{ref2} is injected into optical fiber 610 carrying optical signal 601 at wavelength λ_{sig}. Optical signal 601 and reference signal 613 are tapped into branch 609 and scrambled by a polarization controller acting as a polarization scrambler (PolScr) 606. The polarization controller making up polarization scrambler 606 need not necessarily be endless. Control processor 604 may be used to control polarization scrambler 606. However, a separate control processor may be used to cycle through control voltages for polarization scrambler 606 as there is no need for synchronization with inline endless PC 602. The two wavelength of reference signal 613 are monitored by polarimeter SOP2_{ref1} 614 via filtering splitter Filter2 λ_{ref1} 615 and polarimeter SOP2_{ref2} via filtering splitter Filter2 λ_{ref2} 619. The polarization transformation in the branch can be uniquely identified by two SOPs measured at SOP2_{ref1} and SOP2_{ref2}, corresponding to the two different input reference wavelengths. The filtered scrambled signal is sent through a compensator in the form of a DGD 607 and the signal distortion level is measured by monitor (Mon) 605.

The present embodiment has two independent measurements of two different wavelengths, instead of employing a time dependent multiplexing scheme as shown in FIGS. 4 and 5 employing a polarization rotator 412 or 512. Branch path 609 has polarization scrambler 606 and inline path 608 has endless PC 602. In each path, before the DGD, two simultaneous SOP measurements are taken. So in branch 609, Filter2_{λref1} 615 splits off λ_{ref1} for measurement by SOP2_{ref1} 614 and Filter2_{λref2} 619 splits off λ_{ref2} for measurements by SOP2_{ref2} 618. Similarly, for inline path 608, two SOP measurements are taken. At inline Filter1_{λref1} 617, there is a measurement, SOP1_{ref1} 616 which is λ₁, and at Filter1_{ref2} 621, SOP1_{ref2} 620, whether measurement is at λ₂. The polarization transformation is matched by the monitoring system all the way from tap 622 to the filters and from the filters to DGDs 607 and 603. Preferably free space path 611 is employed from the filters to the DGDs as polarization transformations can not be controlled or monitored beyond the filters. The parameter space is swept out in the branch to find the optimum SOP, corresponding SOP measurements are matched in inline path 608 to ensure the correct optimum in the inline path. Dashed regions 600a and 600b denote free space optical beam paths 611 in which the polarization transformation between SOP_{ref} measurements and the inputs of their respective DGDs (607 and 603) are known and preferably static with no polarization transformation.

FIG. 7 shows single section PMDC 700 which does not require dithering of endless PC 702. Endless PC 702 should be well characterized and controlled for embodiment 700. The SOP, of two reference wavelength, SOP1_{ref1} and SOP_{ref2} are measured at the input of inline Endless PC 702, and control processor 704 calculates the correct setting so that the output of Endless PC 702 matches the optimal value determined from measurements in branch 709.

Reference signal 713 having wavelength λ_{ref1} and λ_{ref2} is injected into optical fiber 710 carrying optical signal 701 at wavelength λ_{sig}. Optical signal 701 and reference signal 713 are tapped to provide branch 709 and the signals are scrambled by a polarization controller acting as a polarization scrambler (PolScr) 706. The polarization controller making up polarization scrambler 706 need not be an endless PC. Control processor 704 may be used to control polarization scrambler 706. However, a separate control processor may be used to cycle through control voltages for polarization scrambler 706 as there is no need for synchronization with inline PC 702. Reference signal 713 is monitored by polarimeter SOP2_{ref1} 714 and SOP2_{ref2} 718 via filtering splitters Filter2_{λref1} 715 and Filter2_{λref2} 719. The polarization transformation in the branch can be uniquely identified by two SOPs measured at SOP2_{ref} and SOP2_{ref2}, corresponding to the two different reference wavelengths. The filtered scrambled signal is sent through DGD 707 acting as a compensator and the signal distortion level is subsequently measured by monitor (Mon) 705.

For inline path 708, two SOP measurements are also taken. At inline Filter1_{λref1} 717, there is a measurement of SOP1_{ref1} 716 which is at λ₁, and at Filter1_{ref2} 721, SOP1_{ref2} 720 is measured at λ₂, both at the input of inline endless PC 702. Processor 704 calculates what voltages or other control parameters need to be applied to endless PC 702 in order to obtain the desired SOPs after inline endless PC 702 as determined in branch 709. Therefore, dithering is not necessary; present embodiment 700 employs only a measurement, calculation and application of tabulated voltages found in memory of controller 704. Preferably, in order for branch SOP_{ref} measurements to match the inline states generated by endless PC 702, there should be no polarization transformations within dashed line boxes 700a and 700b or any such transformations within boxes 700a or 700b are known. This may be facilitated by employing free space optical paths 711a and 711b, or the like

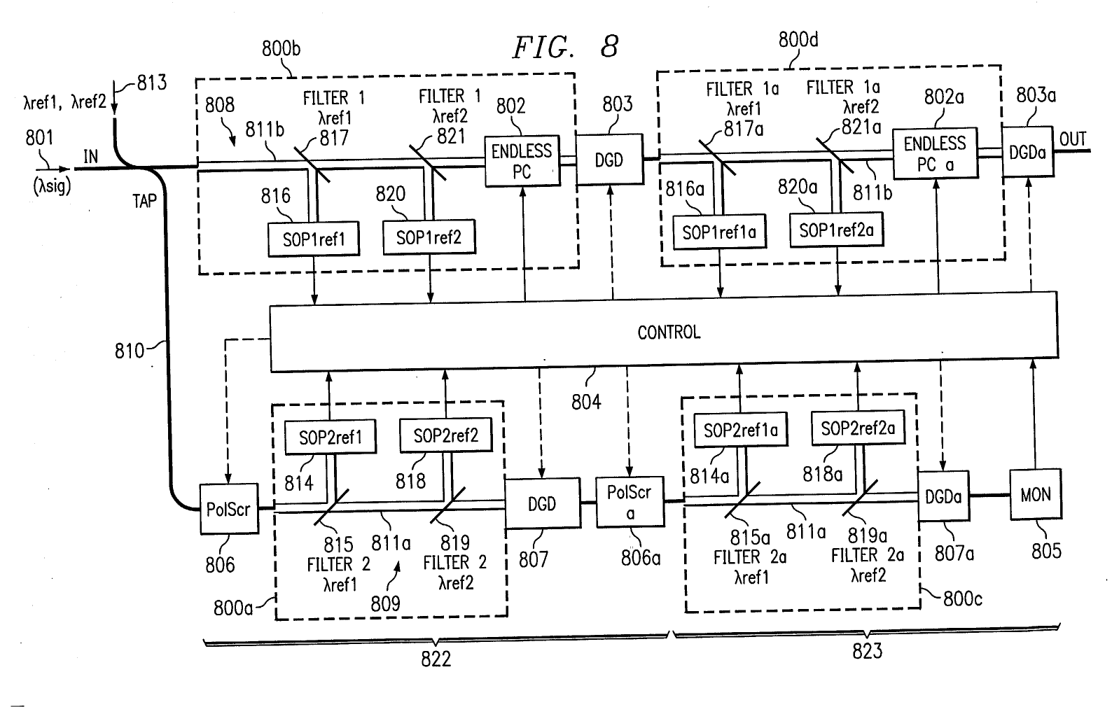

Alternatively, a multi-sequential section embodiment of the above disclosed parallel architecture embodiments may be employed to monitor and control PMD. By way of example, FIG. 8 illustrates a two section embodiment 800 of PMDC parallel monitoring architecture embodiment 700 of FIG. 7. PMDC 800 does not require dithering of endless PCs 802 and 802a. Endless PCs 802 and 802a should be well characterized and controlled for this embodiment. The SOP, of two reference wavelength, SOP1_{ref1} and SOP_{ref2} are measured at the input of each inline Endless PC 802 or 802a, and-control processor 804 calculates the correct setting so that the output of Endless PCs 802 and 802a match the optimal values determined from measurements in branch 809 for each of the respective endless PCs 802 and 802a.

Reference signal 813 having wavelength λ_{ref1} and λ_{ref2} is injected into optical fiber 810 carrying optical signal 801 at wavelength λ_{sig}. Optical signal 801 and reference signal 813 are tapped to provide branch 809 and the signals are scrambled first by polarization scrambler (PolScr) 806, preferably comprised of a polarization controller. The polarization controller used as polarization scrambler 806 need not be an endless PC. Control processor 804 may be used to control polarization scrambler 806. However, a separate control processor may be used to cycle through control voltages for polarization scrambler 806 as there is no need for synchronization with inline PCs 802 or 802a. Reference signal 813 is first monitored by polarimeter SOP2_{ref1} 814 and SOP2_{ref2} 818 via filtering splitters Filter2_{λref1} 815 and Filter2_{ref2} 819. The polarization transformation in branch 809 can be uniquely identified by two SOPs measured at SOP2_{ref} and SOP2_{ref2}, corresponding to the two different reference wavelengths. The filtered scrambled signal is sent through a first compensator 807 in the form of a DGD.

In inline path 808, two SOP measurements are taken at the input of inline endless PC 802. At inline Filter1_{λref1} 817, there is a measurement of SOP1_{ref1} 816 which is at λ₁, and at Filter1_{ref2} 821, SOP_{ref2} 820 is measured at λ₂,. Control processor 804 calculates what voltages or other control parameters need to be applied to endless PC 802 in order to obtain the desired SOPs after inline endless PC 802 as determined in first section 822 of branch 809.

Exiting first section 822 and entering second section 823 optical signal 801 and reference signal 813 in branch 809 are again scrambled, by a second polarization controller acting as polarization scrambler (PolScr) 806a. The polarization controller making up polarization scrambler 806a also need not be an endless PC. Control processor 804 may also be used to control polarization scrambler 806a. However, a separate control processor may be used to cycle through control voltages for polarization scrambler 806a as there is no need for synchronization with inline PC, 802 or 802a. Reference signal 813 is monitored by polarimeter SOP2_{ref1a} 814a and SOP2_{ref2a} 818a via filtering splitters Filter2_{λref1} 815a and Filter2_{ref2} 819a, respectively. The polarization transformation in branch 809 can again be uniquely identified by two SOPs measured at SOP2_{ref} and SOP2_{ref2}, corresponding to the two different reference wavelengths. The filtered scrambled signal is sent through compensator 807a in the form of a DGD and the signal distortion level is measured by monitor (Mon) 805.

Again in inline path 808, two SOP measurements are taken at the input of inline endless PC 802a. At inline Filter1a_{λref}, 817a, there is a measurement of SOP1_{ref1a} 816a which is at λ₁, and at Filter1a_{ref2} 821a, SOP1_{ref2a} 820a is measured at λ₂,. Processor 804 also calculates what voltages or other control parameters need to be applied to endless PC 802a in order to obtain the desired SOPs after inline endless PC 802a as determined in second section 823 of branch 809.

Dithering is not necessary for embodiment 800. Measurements, calculations and application of tabulated voltages found in memory of controller 804 are employed to control endless PCs 802 and 802a. Preferably free space paths 811a and 811b are employed from the filters to the DGDs in each section as polarization transformations can not be controlled or monitored beyond the filters. Dashed outlines 800a, 800b, 800c and 400d encompass free space optical beam paths 811a and 811b, or other well defined optical path, in which the polarization transformation between SOP_{ref} measurements and the inputs of their respective DGDs are known. Preferably, no polarization transformation takes place within boxes 800a, 800b, 800c or 800d.

By requiring two input reference SOPs or wavelengths. The embodiments of FIGS. 4 through 8 accomplish matching of polarization transformations between inline paths and branches by sensing output polarization states for two distinct input polarizations. Herein, distinct means that the two SOPs are not only different, but are not orthogonal states either this distinction is due to the ambiguity of SOP measurements; an SOP inherently contains two degrees of freedom. Therefore, a single SOP measurement cannot fully describe a polarization transformation. A second input SOP will provide missing information, as long as the second SOP is not orthogonal to the first SOP. When plotted on a Poincaré sphere, the second SOP will ideally occupy a position 90 degrees relative to the first SOP. “Orthogonal” corresponds to a 180 degree relative position on the Poincare sphere.

The dashed line boxes 400a, 400b, 500a, 500b, 600a, 600b, 700a, 700b, 800a, 800b, 800c and 800d are regions in which polarization transformations are preferably known and are preferably static. Within these boxes measured reference SOPs are intended to correlate to signal polarization orientation with respect to the subsequent DGD principal states. The polarization transformations within all fiber connections out side dashed boxes 400a, 400b, 500a, 500b, 600a, 600b, 700a, 700b, 800a, 800b, 800c and 800d are preferably free to drift. The present systems and methods are intended to adjust for such variations.

In present parallel architecture embodiments 300, 400, 500, 600, 700 and 800 the branch and inline DGDs do not need to match in terms of optical birefringence. This precludes the DGDs from susceptibility to unequal thermal drifting, making design of a parallel monitoring architecture practical. Additionally, as mentioned above, branch polarization scramblers need not be endless PCs in these embodiments. Instead, the polarization scramblers can be components of lower cost. If desired, a third degree of freedom, tunability of DGDs, can be added to these embodiments. This tunability is denoted by dashed control lines from controls to the DGDs of each embodiment.

Preferably, PMD monitors (MONs 305, 405, 505, 605, 705 and 805) are distortion level monitors. For example, a degree of polarization (DOP) measurement system can be employed as a monitor, such a DOP measurement system may be a polarimeter which measures Stokes parameters, from which a DOP can be extracted. Also, a polarization scrambler may be used in conjunction with a polarizer as a monitor. By finding the ratio of the minimum to maximum transmitted power using a scrambler and polarizer the DOP may be extracted. RF measurements may be employed as a means of monitoring PMD. By filtering certain frequencies from a photo-detector which receives the branch or inline optical signal branch or inline distortion levels due to PMD can be extracted from the electrical signal.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for providing parallel monitoring and control of a polarization mode dispersion compensator comprising the steps of:
splitting an optical signal carried by an optical signal path between an inline path and a branch path;
controlling polarization mode dispersion of said optical signal in each of said paths independently; and
adjusting said polarization mode dispersion control of said optical signal in said inline path in response to said optical signal in said branch path.

2. The method of claim 1 wherein said adjusting step further comprises the step of monitoring polarization mode dispersion of said optical signal in said branch path to determine control parameters for said polarization mode dispersion control in said inline path.

3. The method of claim 1 wherein said splitting and said controlling steps are carried out employing an optical medium free of polarization transformations and polarization mode dispersion.

4. The method of claim 1 wherein said splitting and said controlling steps are carried out employing an optical medium for which polarization transformations and polarization mode dispersion are known.

5. The method of claim 1 further comprising the step of repeating said controlling and adjusting steps at least one additional time.

6. The method of claim 5 wherein said repeating step is carried out in at least one additional section of said compensator.

7. The method of claim 2 further comprising the step of injecting at least one reference signal into said optical signal path.

8. The method of claim 7 further comprising the step of scrambling polarization of said optical and reference signals in said branch path.

9. The method of claim 7 further comprising the step of repeating said controlling and adjusting steps at least one additional time.

10. The method of claim 7 further comprising the step of measuring at least one optical attribute of said reference signal in said branch path for adjusting said polarization mode dispersion control in said inline path.

11. The method of claim 10 wherein said measuring step further comprises measuring said at least one optical attribute of said reference signal in said inline path for adjusting said polarization mode dispersion control in said inline path.

12. The method of claim 11 further comprising matching said at least one optical attribute of said reference signal in said inline path to said at least one optical attribute of said reference signal in said branch path to provide said polarization mode dispersion control.

13. The method of claim 12 wherein at least one of said measured attributes is at least one state of polarization of said reference signal.

14. The method of claim 12 wherein said measuring step is carried out employing an optical medium free of polarization transformations and polarization mode dispersion.

15. The method of claim 12 wherein said measuring step is carried out employing an optical medium for which polarization transformations and polarization mode dispersion are known.

16. The method of claim 12 wherein said injecting step further comprises the step of rotating polarizations of said reference signal to provide a plurality of states of polarization to said reference signal.

17. The method of claim 16 wherein said states of polarization differ and are non-orthogonal.

18. The method of claim 12 wherein said measuring in said inline path is carried out after said signals pass through a polarization controller.

19. The method of claim 12 further comprising the step of repeating said controlling, adjusting and measuring steps at least one additional time.

20. The method of claim 12 wherein said measuring in said inline path is carried out before said signals pass through a polarization controller.

21. The method of claim 20 further comprising the step of applying a set of stored control parameters to said inline polarization controller in response to said measurements of states of polarization in said branch and said inline paths providing dither free control of said polarization controller.

22. The method of claim 20 further comprising the step of repeating said controlling and adjusting steps at least one additional time.

23. The method of claim 1 further comprising the step of injecting a plurality of reference signals, at different wavelengths and polarization states, into said optical signal path.

24. The method of claim 23 further comprising the step of scrambling polarization of said optical and reference signals in said branch path.

25. The method of claim 23 further comprising the step of measuring at least one optical attribute of said reference signal in said branch path for adjusting said polarization mode dispersion control in said inline path.

26. The method of claim 25 wherein said measuring step further comprises measuring said at least one optical attribute of said reference signal in said inline path for adjusting said polarization mode dispersion control in said inline path.

27. The method of claim 26 further comprising matching said at least one optical attribute of said reference signal in said inline path to said at least one optical attribute of said reference signal in said branch path to provide said polarization mode dispersion control.

28. The method of claim 27 wherein at least one of said measured attributes is at least one state of polarization of said reference signal.

29. The method of claim 27 wherein said measuring step is carried out employing an optical medium free of polarization transformations and polarization mode dispersion.

30. The method of claim 27 wherein said measuring step is carried out employing an optical medium for which polarization transformations and polarization mode dispersion are known.

31. The method of claim 23 wherein said measuring in said inline path is carried out after said signals pass through a polarization controller.

32. The method of claim 31 further comprising the step of repeating said controlling and adjusting steps at least one additional time.

33. The method of claim 23 wherein said measuring in said inline path is carried out before said signals pass through a polarization controller.

34. The method of claim 33 further comprising the step of applying a set of stored control parameters to said inline polarization controller in response to said measurements of states of polarization in said branch and said inline paths, providing dither free control of said polarization controller.

35. The method of claim 33 further comprising the step of repeating said controlling and adjusting steps at least one additional time.

36. A parallel monitored and controlled optical polarization mode dispersion compensator comprising:
an inline optical signal path carrying an optical signal;
a branch optical signal path split from said inline path, said branch path and said inline path both carrying said optical signal;
a polarization controller disposed in said inline path;
a differential group delay disposed in said inline path;
a polarization controller disposed in said branch path;
a differential group delay disposed in said branch path; and
a control adjusting control parameters of said polarization controller in said inline path in response to polarization mode dispersion of said optical signal in said branch path.

37. The compensator of claim 36 further comprising a monitor disposed in said branch path monitoring polarization mode dispersion of said optical signal in said branch path, said monitor providing a monitor signal to said control for use in adjusting said control parameters of said inline polarization controller.

38. The compensator of claim 37 wherein said polarization controller disposed in said optical path and said polarization controller disposed in said branch path match.

39. The compensator of claim 37 wherein said control adjusts control parameters of said differential group delay disposed in said optical signal path.

40. The compensator of claim 36 further comprising at lest one additional section, said additional section comprising:
an additional polarization controller disposed in said inline path;
an additional differential group delay disposed in said inline path;
an additional polarization controller disposed in said branch path;
an additional differential group delay disposed in said branch path; and
wherein said control independently adjusts said control parameters for said polarization controller and said additional polarization controller in said inline path in response to polarization mode dispersion of said optical signal in said branch path.

41. The compensator of claim 40 further comprising a monitor disposed in said branch path monitoring polarization mode dispersion of said optical signal in said branch path, said monitor providing a monitor signal to said control for use in adjusting said control parameters of said inline polarization controller and said inline additional polarization controller.

42. The compensator of claim 37 further comprising a polarization rotator injecting at least one reference signal into said inline and branch paths.

43. The compensator of claim 42 wherein said polarization rotator injects said at least one reference signal into said inline path before said branch path, whereby said inline path and said branch path carry a same at least one reference signal.

44. The compensator of claim 43 wherein said at least one reference signal has a plurality of states of polarization.

45. The compensator of claim 44 wherein said states of polarization differ and are nonorthogonal.

46. The compensator of claim 42 further comprising at lest one additional section, said additional section comprising:
an additional polarization controller disposed in said inline path;
an additional differential group delay disposed in said inline path;
an additional polarization controller disposed in said branch path;
an additional differential group delay disposed in said branch path; and
wherein said control independently adjusts said control parameters for said polarization controller and said additional polarization controller in said inline path in response to polarization mode dispersion of said optical signal in said branch path.

47. The compensator of claim 43 wherein said polarization controller disposed in said branch path acts as a polarization scrambler and said compensator further comprises at least one polarimeter disposed in said inline path and at least one polarimeter disposed in said branch path for measuring at least one state of polarization of said at least one reference signal in each of said paths.

48. The compensator of claim 47 wherein said at least one state of polarization of said at least one reference signal of said branch path is provided to said control for adjusting said control parameters of said inline polarization controller in light of said at least one state of polarization of said at least one reference signal in said inline path.

49. The compensator of claim 48 wherein said polarization scrambler cycles through control parameters.

50. The compensator of claim 49 wherein said inline polarimeter is disposed in said inline path after said inline polarization controller and said branch path polarimeter is disposed in said branch path after said branch path polarization controller.

51. The compensator of claim 50 further comprising at lest one additional section, said additional section comprising:
an additional polarization controller disposed in said inline path;
an additional polarimeter disposed in said inline path after said additional inline polarization controller;
an additional differential group delay disposed in said inline path;
an additional polarization controller disposed in said branch path;
an additional polarimeter disposed in said branch path after said additional branch polarization controller;
an additional differential group delay disposed in said branch path; and
wherein said control independently adjusts said control parameters for said polarization controller and said additional polarization controller in said inline path in response to polarization mode dispersion of said optical signal in said branch path.

52. The compensator of claim 49 wherein said control comprises a stored set of said control parameters for said inline polarization controller for correcting states of polarization of an optical signal.

53. The compensator of claim 48 wherein said inline polarimeter is disposed in said inline path before said inline polarization controller and said branch path polarimeter is disposed in said branch path after said branch path polarization controller, whereby said at least one state of polarization of said at least one reference signal of said branch path is provided to said control to provide dither free control of said inline polarization controller.

54. The compensator of claim 53 further comprising at lest one additional section, said additional section comprising:
an additional polarimeter disposed in said inline path;
an additional polarization controller disposed in said inline path after said additional inline polarimeter;
an additional differential group delay disposed in said inline path;
an additional polarization controller disposed in said branch path;
an additional polarimeter disposed in said branch path after said additional branch polarization controller;
an additional differential group delay disposed in said branch path; and
wherein said control independently adjusts said control parameters for said polarization controller and said additional polarization controller in said inline path in response to polarization mode dispersion of said optical signal in said branch path.

55. The compensator of claim 42 wherein said control cycles through control parameters for said polarization scrambler.

56. The compensator of claim 37 wherein said optical signal further comprises a plurality of reference signals having different wavelengths and polarization states.

57. The compensator of claim 56 wherein said reference signals are injected into said inline path before said branch path, whereby said inline path and said branch path carry a same set of reference signals.

58. The compensator of claim 57 wherein said polarization controller disposed in said branch path acts as a polarization scrambler and said compensator further comprises a plurality of polarimeters disposed in said inline path and a plurality of polarimeters disposed in said branch path for measuring a corresponding state of polarization of each of said reference signals in each of said paths.

59. The compensator of claim 58 wherein said state of polarization of each of said reference signals of said branch path is provided to said control for adjusting said control parameters of said inline polarization controller in light of said state of polarization of each of said reference signals in said inline path.

60. The compensator of claim 59 wherein said polarization scrambler cycles through control parameters.

61. The compensator of claim 60 wherein said inline polarimeters are disposed in said inline path after said inline polarization controller and said branch path polarimeters are disposed in said branch path after said branch path polarization controller.

62. The compensator of claim 61 further comprising at lest one additional section, said additional section comprising:
an additional polarization controller disposed in said inline path;
an additional plurality of polarimeters disposed in said inline path after said additional inline polarization controller;
an additional differential group delay disposed in said inline path;
an additional polarization controller disposed in said branch path;
an additional plurality of polarimeters disposed in said branch path after said additional branch polarization controller;
an additional differential group delay disposed in said branch path; and
wherein said control independently adjusts said control parameters for said polarization controller and said additional polarization controller in said inline path in response to polarization mode dispersion of said optical signal in said branch path.

63. The compensator of claim 60 wherein said control comprises a stored set of said control parameters for said inline polarization controller for correcting states of polarization mode dispersion in an optical signal.

64. The compensator of claim 63 wherein said inline polarimeters are disposed in said inline path before said inline polarization controller and said branch path polarimeters are disposed in said branch path after said branch path polarization controller, whereby said state of polarization of each of said reference signals of said branch path is provided to said control to provide dither free control of said inline polarization controller.

65. The compensator of claim 64 further comprising at lest one additional section, said additional section comprising:
an additional plurality of polarimeters disposed in said inline path;
an additional polarization controller disposed in said inline path after said additional plurality of inline polarimeters;
an additional differential group delay disposed in said inline path;
an additional polarization controller disposed in said branch path;
an additional plurality of polarimeters disposed in said branch path after said additional branch polarization controller;
an additional differential group delay disposed in said branch path; and
wherein said control independently adjusts said control parameters for said polarization controller and said additional polarization controller in said inline path in response to polarization mode dispersion of said optical signal in said branch path.

66. The compensator of claim 60 wherein said control cycles through control parameters for said polarization scrambler.

67. The compensator of claim 36 wherein said inline polarization controller is an endless polarization controller.
